(19) United States
(12) Patent Application Publication
(10) Pub. No.: US 2010/0244495 A1
(43) Pub. Date: Sep. 30, 2010

(54) PHASE CHANGE MATERIAL USAGE IN WINDOW TREATMENTS

(75) Inventors: Jennifer P. Lawall, Waterford, MI (US); Hans P. Lawall, Waterford, MI (US); Diane K. McQueen, Leonard, MI (US); Carol C. Hathaway, Rochester, MI (US)

Correspondence Address: Quinn Law Group, PLLC, 39555 Orchard Hill Place, Suite 520, Novi, MI, 48375, US

(73) Assignee: GM GLOBAL TECHNOLOGY OPERATIONS, INC., Detroit, MI (US)

(21) Appl. No.: 12/412,887

(22) Filed: Mar. 27, 2009

(51) Int. Cl. B60J 1/00; E06B 3/28; B21D 53/88

(52) U.S. Cl. 296/201; 52/203; 29/897.2

(57) ABSTRACT

The window assembly for a vehicle includes a first portion supported by the vehicle and a second portion located proximate to the first portion. The second portion includes a phase change material (PCM) barrier.

### TECHNICAL FIELD

The present invention relates, generally, to a window treatment for an automotive vehicle, and more specifically, to a window treatment having a phase change material.

### BACKGROUND OF THE INVENTION

Automotive vehicles are typically equipped with multiple windows located around the passenger compartment of the vehicle. In addition to allowing the passengers to see from within the passenger compartment, the windows allow light and heat into the passenger compartment when the vehicle is in use and when the vehicle is parked. Over time the light and heat can cause wear to components within the passenger compartment. Additionally, the passenger compartment can become uncomfortably warm for passengers due to the heat from the environment, especially in warm climates. Commonly, consumers use cardboard or reflective materials to block the windshield when the vehicle is not in use. However these materials may be bulky and difficult to use and have limited effectiveness.

### SUMMARY OF THE INVENTION

A window treatment or a window assembly for a vehicle that includes a phase change material is provided. The window assembly includes a first portion supported by the vehicle and a second portion located proximate to the first portion. The second portion includes a phase change material (PCM) barrier. As the phase change material approaches the temperature of the phase change the material absorbs heat from the environment, but minimal change to the temperature of the material occurs as a result.

A method of producing the window assembly for the vehicle includes securing the first portion of the window assembly to the vehicle. The second portion is then adhered to the first portion.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic top view illustration of an automotive vehicle having a first embodiment of a window assembly with a barrier of PCM material;

FIG. 2 is an enlarged schematic perspective illustration of the first embodiment of a window assembly having a barrier with a PCM material for the automotive vehicle of FIG. 1;

FIG. 3 is an enlarged schematic perspective illustration of a second embodiment of a window assembly having a barrier with a PCM material for the automotive vehicle of FIG. 1;

FIG. 4 is an enlarged schematic cross-sectional illustration of a third embodiment of a window assembly having a barrier with a PCM material for the automotive vehicle of FIG. 1;

FIG. 5 is an enlarged schematic cross-sectional illustration of a fourth embodiment of a window assembly including a window treatment having a barrier with a PCM material for the automotive vehicle of FIG. 1;

FIG. 6 is an enlarged schematic cross-sectional illustration of a fifth embodiment of a window assembly including a window treatment having a barrier with a PCM material for the automotive vehicle of FIG. 1;

FIG. 7 is an enlarged schematic cross-sectional illustration of a sixth embodiment of a window assembly including a window treatment having a barrier with a PCM material for the automotive vehicle of FIG. 1; and

FIG. 8 is an enlarged schematic cross-sectional illustration of seventh embodiment of a window assembly including a window treatment having a barrier with a PCM material for the automotive vehicle of FIG. 1.

### DESCRIPTION OF THE PREFERRED EMBODIMENTS

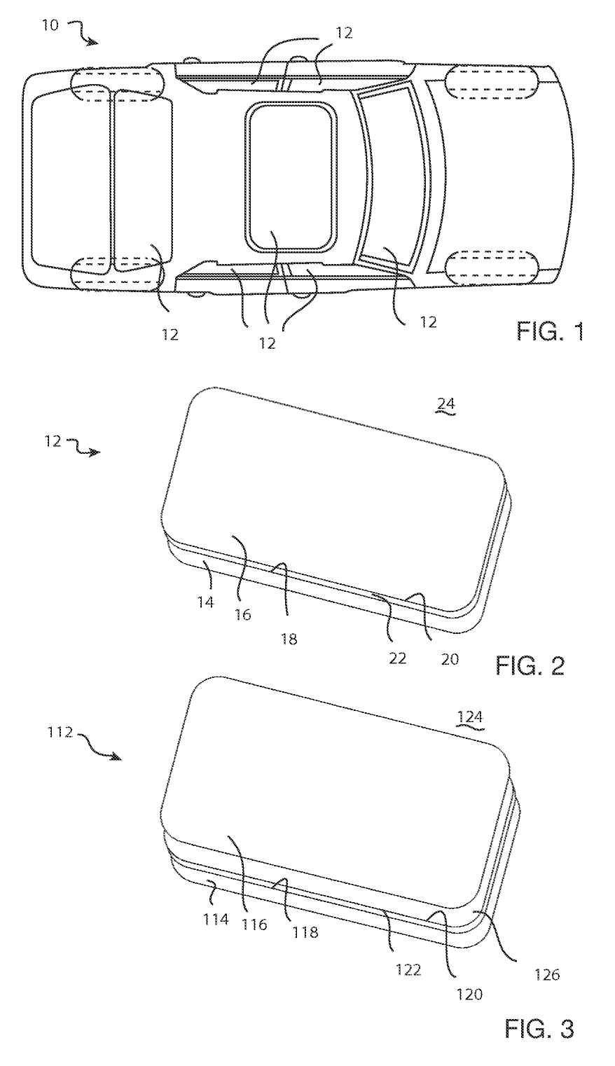

Referring to the Figures, wherein like reference numbers refer to the same or similar components throughout the several views, FIG. 1 schematically illustrates a top view of an automotive vehicle 10. The vehicle 10 includes a plurality of window assemblies 12. The window assemblies 12 may include but are not limited to a windshield, a rear window, multiple left and right-side passenger windows, a sunroof/moonroof, or a panoramic windshield.

FIG. 2 is an enlarged schematic perspective illustration of a first embodiment of a portion of a window assembly 12 for the vehicle 10 (shown in FIG. 1). The window assembly 12 preferably includes a first portion 14 formed of glass or other transparent materials for forming windows, as is known in the art. A second portion 16 is adhered to the first portion 14. The second portion 16 includes a phase change material (PCM) barrier 22. The second portion 16 may also include a first film 18 and a second film 20. The first film 18 and the second film 20 enclose the PCM barrier 22. The second portion 16, including the first film 18, the second film 20 and the PCM barrier 22, is also formed of transparent materials.

The PCM barrier 22 absorbs heat from the environment 24 around the window assembly 12 to protect the interior of the vehicle 10 (shown in FIG. 1). The environment 24 may include the vehicle 10 exterior or interior. For example, the PCM barrier 22 absorbs heat from the exterior of the vehicle 10 preventing the interior of the vehicle 10 from heating from the sun in warm climates. Absorption of heat by the PCM barrier 22 assists in protecting components within the passenger compartment (not shown) of the vehicle 10 and reduce wear on the components that may result from heat cycling. Additionally, the absorption of the exterior heat by the PCM barrier 22 assists in maintaining a more comfortable temperature within the passenger compartment of the vehicle 10 when the vehicle 10 is parked or in use. Alternatively, the PCM barrier 22 may absorb heat from the interior of the vehicle 10 to prevent the vehicle interior from cooling, for example in cool climates, to assist in maintaining a comfortable temperature within the passenger compartment during vehicle 10 use, or when the vehicle 10 is parked.

The PCM barrier 22 absorbs heat from the environment 24 as the phase change material changes from a solid to a liquid; this is known as latent heat absorption. Although phase change materials can store and release energy for any phase change (i.e. solid to liquid, liquid to gas, etc) the embodiment disclosed is for the solid to liquid phase change. As the PCM barrier 22 absorbs heat the PCM barrier 22 approaches the temperature of the phase change for the material. When the PCM barrier 22 reaches the phase change temperature the PCM absorbs heat at an almost constant temperature, as is known. The PCM barrier 22 continues to absorb heat until the phase change is entirely complete. However, the phase change of the PCM barrier 22 may or may not occur depending on the amount of heat being absorbed from the environment 24 at that time and the material selected for the PCM barrier 22. Additionally, the PCM barrier 22 may only partially complete a phase change. The material forming the PCM barrier 22 is selected based upon the ability of the material to absorb heat prior to the phase change and the temperature at which the phase change occurs. For example, the PCM barrier 22 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Further, the thickness of the PCM barrier 22 may also determine the amount of heat the PCM can absorb. The thickness of PCM barrier 22 may include an increased thickness, or multiple sheets of phase change material in the second portion 16. That is, multiple sheets of one type of PCM may be included in the PCM barrier 22 or multiple sheets each of a different type of PCM may be included in the PCM barrier 22.

The second portion 16 with the PCM barrier 22 may be located on an exterior side of the window assembly 12 or may be located on an interior side of the window assembly 12. The location of the second portion 16 relative to the first portion 14 does not prohibit the ability of the PCM barrier 22 to absorb heat from the surrounding environment. The location of the first portion 14 on the exterior or interior side of the second portion 16 may depend on several factors including the intended climate for the vehicle 10, protection of the second portion 16 from the external or internal environment, or ease of assembly. The second portion 16 may be adhered to the first portion 14 either before or after assembly of the vehicle 10 and does not necessarily need to occur at the same time as assembly of the vehicle 10, i.e. the second portion 16 could be on an aftermarket vehicle.

The first film 18 and the second film 20 assist in enclosing the PCM barrier 22 in instances where the PCM barrier 22 undergoes a phase change and is in liquid form. The second portion 16, with the first film 18, the second film 20 and the PCM barrier 22, may be preassembled prior to adhering the second portion 16 to the first portion 14. Alternatively, the PCM barrier 22 may be formed of an encapsulated phase change material, to be-self containing. In this instance the second portion 16 does not require the first film 18 and the second film 20 to contain the PCM barrier 22 when in liquid form.

FIG. 3 is an enlarged schematic perspective illustration of a second embodiment of a portion of a window assembly 112 for the vehicle 10 (shown in FIG. 1). The window assembly 112 preferably includes a first portion 114 formed of glass or other transparent materials for forming windows, as is known in the art. A second portion 116 is adhered to the first portion 114. The second portion 116 includes a PCM barrier 122. The second portion 116 may also include a first film 118 and a second film 120. The first film 118 and the second film 120 enclose the PCM barrier 122. A third portion 126 is a located on an opposing side of the second portion 116 from the first portion 114. The second portion 116, including the first film 118, the second film 120 and the PCM barrier 122, is also formed of transparent materials.

Similar to the first portion 114, the third portion 126 is formed of glass or other transparent materials for forming windows, as is known in the art. The second portion 116 is adhered to at least one of the first portion 114 and the third portion 126. The first portion 114 and the third portion 126 enclose and protect the second portion 116.

The PCM barrier 122 absorbs heat from the environment 124 around the window assembly 112 to protect the interior of the vehicle 10 (shown in FIG. 1). The environment 124 may include the vehicle 10 exterior or interior. The PCM barrier 122 may absorb heat from the exterior of the vehicle 10 to protect the interior of the vehicle 10, such as preventing the interior of the vehicle 10 from heating from the sun in warm climates. Absorption of heat by the PCM barrier 122 would assist in protecting components within the passenger compartment (not shown) of the vehicle 10 and reduce wear on the components that may result from heat cycling. Additionally, the absorption of the exterior heat by the PCM barrier 122 may assist in maintaining a more comfortable temperature within the passenger compartment of the vehicle 10 when the vehicle 10 is parked or in use. Alternatively, the PCM barrier 122 may absorb heat from the interior of the vehicle 10 to prevent the vehicle interior from cooling, for example in cool climates, to assist in maintaining a comfortable temperature within the passenger compartment when the vehicle 10 is in use or when the vehicle 10 is parked.

The PCM barrier 122 absorbs heat from the environment 124 as the phase change material changes from a solid to a liquid. As the PCM barrier 122 absorbs heat, the PCM barrier 122 approaches the point of the phase change for the material. The phase change of the PCM barrier 122 may or may not occur depending on the amount of heat being absorbed from the environment 124 at that time and the material selected for the PCM barrier 122. The material forming the PCM barrier 122 is selected based upon the ability of the material to absorb heat prior to the phase change and the temperature at which the phase change occurs. For example, the PCM barrier 122 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Additionally, the PCM barrier 122 may include multiple sheets of phase change material in the second portion 116. That is, multiple sheets of one type of PCM may be included in the PCM barrier 122 or multiple sheets each of a different type of PCM may be included in the PCM barrier 122.

The first film 118 and the second film 120 assist in enclosing the PCM barrier 122 in instances where the PCM barrier 122 undergoes a phase change and is in liquid form. The second portion 116 with the first film 118, the second film 120 and the PCM barrier 122 may be preassembled prior to adhering the second portion 116 to the first portion 114 and the third portion 126. Due to the location of the second portion, between the first portion 114 and the third portion 126, the second portion 116 may include only the PCM barrier 122 and not require the first film 118 and the second film 120. In this instance, the first portion 114 and the third portion 126 would protect the PCM barrier during any phase change. Alternatively, the PCM barrier 122 may be formed of an encapsulated phase change material to be self-containing. In this instance also, the second portion 116 does not require the first film 118 and the second film 120 to contain the PCM barrier 122 when in liquid form.

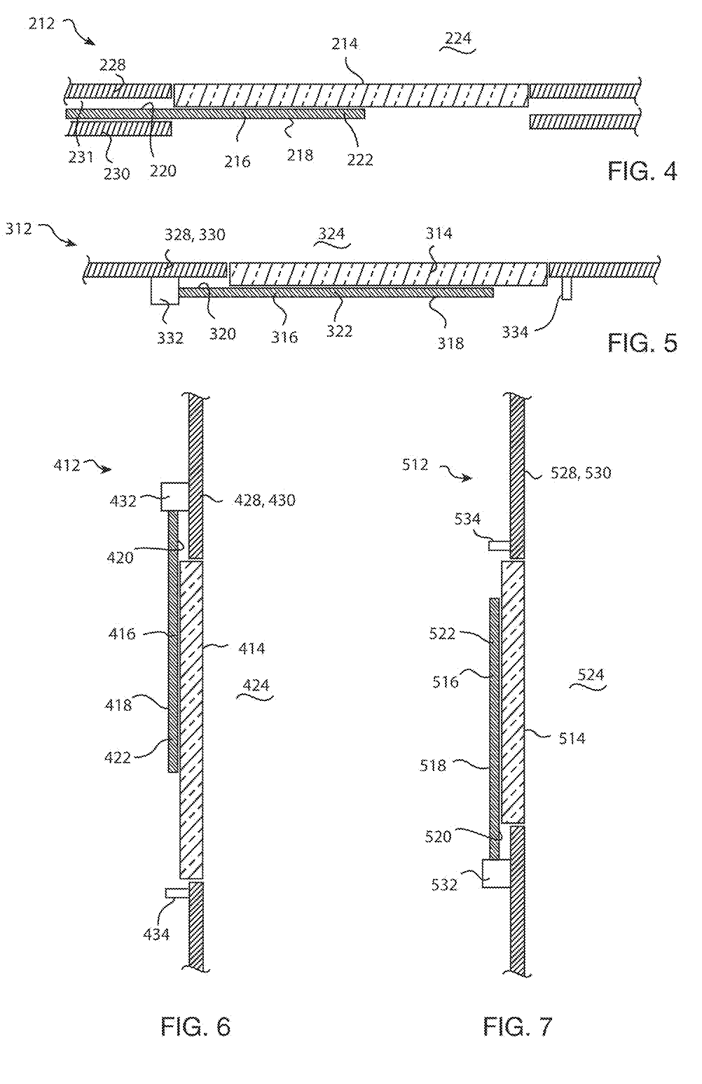

FIG. 4 is an enlarged schematic perspective illustration of a third embodiment of a portion of a window assembly 212 for the vehicle 10 (shown in FIG. 1). The window assembly 212 preferably includes a first portion 214 formed of glass or other transparent materials for forming windows, as is known in the art. A second portion 216 is located proximate to the first portion 214. The second portion 216 includes phase change material (PCM) barrier 222. A first film 218 and a second film 220 may also be included and enclose the PCM barrier 222.

In the embodiment shown, the window assembly 212 is mounted to the body 228 of the vehicle 10. An interior panel 230 for the vehicle 10 is spaced apart from the body 228. For example, if the window assembly 212 is for a sunroof than the body 228 is the roof and the interior panel 230 is a headliner for the vehicle 10. The second portion 216 is located at least partially in a cavity 231 defined by the body 228 and the interior panel 230. The second portion 216 may be translated axially to extend from the cavity and substantially cover the first portion 214, or retracted within the cavity 231. As shown, the second portion 216 is partially extended from the cavity 231 and partially covers the first portion 214. In the example above, the second portion 216 may be a cover panel for the sunroof. The second portion 216 does not need to be transparent as it can be retracted within the cavity 231 as required.

As mentioned above, the PCM barrier 222 is located between a first film 218 and a second film 220. The second portion 216, including the first film 218, the second film 220, and the PCM barrier 222 may be rigid, as in part of a panel, or may be flexible to form a curtain over the first portion 214.

The PCM barrier 222 absorbs heat from the environment 224 around the window assembly 212. The environment 224 may include the vehicle 10 (shown in FIG. 1) exterior or interior. The PCM barrier 222 may absorb heat from the exterior of the vehicle 10 to protect the interior of the vehicle 10, such as preventing the interior of the vehicle 10 from heating from the sun in warm climates. Absorption of heat by the PCM barrier 222 would assist in protecting components within the passenger compartment (not shown) of the vehicle 10 from damage caused by exposure to the heat and reduce wear on the components that may result from heat cycling. Additionally, the absorption of the exterior heat by the PCM barrier 222 may assist in maintaining a more comfortable temperature within the passenger compartment of the vehicle 10 when the vehicle 10 is parked or in use. Alternatively, the PCM barrier 222 may absorb heat from the interior of the vehicle 10 to prevent the vehicle 10 interior from cooling, for example in cool climates, to assist in maintaining a comfortable temperature within the passenger compartment during vehicle 10 use, or when the vehicle 10 is parked.

The PCM barrier 222 absorbs heat from the environment 224 as the phase change material changes from a solid to a liquid. As the PCM barrier 222 absorbs heat the PCM barrier 222 approaches the point of the phase change for the material. The phase change of the PCM barrier 222 may or may not occur depending on the amount of heat being absorbed from the environment 224 at that time and the material selected for the PCM barrier 222. The material forming the PCM barrier 222 is selected based upon the ability of the material to absorb heat prior to the phase change and the temperature at which the phase change occurs. For example, the PCM barrier 222 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Additionally, the PCM barrier 222 may include multiple sheets of phase change material in the second portion 216. That is, multiple sheets of one type of PCM may be included in the PCM barrier 222 or multiple sheets each of a different type of PCM may be included in the PCM barrier 222.

The first film 218 and the second film 220 assist in enclosing the PCM barrier 222 in any instances where the PCM barrier 222 undergoes a phase change and is in liquid form. The first film 218 and the second film 220 may also provide rigidity and support to the PCM barrier 222. Alternatively, the PCM barrier 222 may be formed of an encapsulated phase change material to be self-containing. In this instance also the second portion 216 does not require the first film 218 and the second film 220 to contain the PCM barrier 222 when in liquid form. The first film 218 and the second film 220 may still be included though to provide support to the PCM barrier 222.

FIG. 5 is an enlarged schematic perspective illustration of a third embodiment of a portion of a window assembly 312 for the vehicle 10 (shown in FIG. 1). The window assembly 312 preferably includes a first portion 314 formed of glass or other transparent materials for forming windows, as is known in the art. A second portion 316 is located proximate to the first portion 314. The second portion 316 includes phase change material (PCM) barrier 322. A first film 318 and a second film 320 may also be included in the second portion 316 and enclose the PCM barrier 322.

In the embodiment shown the window assembly 312 is mounted to either a body 328 of the vehicle 10 or an interior panel 330 for the vehicle 10. A housing 332 is mounted to the body 328 or the interior panel 330, as shown. Alternately, the housing 332 may be removably mounted to the first portion 314 of the window assembly 312. For example the housing 332 may be secured to the first portion 314 using suction cups.

The second portion 316 is supported by and extends from the housing 332 to cover the first portion 314. The second portion 316 may be extended from the housing 332 to cover the first portion 314, or retracted within the housing 332 for storage. For example, the housing 332 and the second portion 316 could be a roller shade system or other type of window shade system. A securing mechanism 334 may be secured to the body 328 or the interior panel 330 on an opposing side of the window assembly 312 from the housing 332. In the instance when the housing 332 is secured to the first portion 314, the securing mechanism may also be secured on the first portion 314 and spaced apart from the housing 332. When the second portion 316 is fully extended (shown partially extended) the securing mechanism 334 assists in retaining the second portion 316 proximate to the first portion 314. When the second portion 316 is in the fully extended position the second portion 316 covers a substantial area of the first portion 314 to absorb heat from the environment 324.

As mentioned above the second portion 316 includes the PCM barrier 322 and is located between a first film 318 and a second film 320. The second portion 316, including the first film 318, the second film 320, and the PCM barrier 322 may be rigid, as in part of a panel, or may be flexible to form a curtain over the first portion 314. In the embodiment shown the second portion 316 does not need to be transparent. The first portion 314 is retracted within the housing 332 during vehicle operation so the first portion 314 of the window assembly 312, which is transparent, may be seen through. When the vehicle 10 is not operating, the second portion 316 is extended over the first portion 314 to absorb heat from the environment 324 as described below. In FIG. 4, the second portion 316 is shown partially extended.

Alternatively, the housing 332 may pivot relative to the body 328 or the interior panel 330. The second portion 316 would pivot with the housing 332 in a visor-like manner. The second portion 316 could be pivoted away from the first portion 314 for storage and pivoted to cover at least a part of the first portion 314 to use the PCM barrier 322 to absorb heat.

The PCM barrier 322 absorbs heat from the environment 324 around the window assembly 312. The environment 324 may include the vehicle 10 (shown in FIG. 1) exterior or interior. The PCM barrier 322 may absorb heat from the exterior of the vehicle 10 to protect the interior of the vehicle 10, such as preventing the interior of the vehicle 10 from heating from the sun in warm climates. Absorption of heat by the PCM barrier 322 would assist in protecting components within the passenger compartment (not shown) of the vehicle 10 from damage caused by exposure to the heat and reduce wear on the components that may result from heat cycling. Additionally, the absorption of the exterior heat by the PCM barrier 322 may assist in maintaining a more comfortable temperature within the passenger compartment of the vehicle 10 when the vehicle 10 is parked or in use. Alternatively, the PCM barrier 322 may absorb heat from the interior of the vehicle 10 to prevent the vehicle 10 interior from cooling, for example in cool climates, to assist in maintaining a comfortable temperature within the passenger compartment during vehicle 10 use, or when the vehicle 10 is parked.

The PCM barrier 322 absorbs heat from the environment 324 as the phase change material changes from a solid to a liquid. As the PCM barrier 322 absorbs heat, the PCM barrier 322 approaches the point of the phase change for the material. The phase change of the PCM barrier 322 may or may not occur depending on the amount of heat being absorbed from the environment 324 at that time and the material selected for the PCM barrier 322. The material forming the PCM barrier 322 is selected based upon the ability of the material to absorb heat prior to the phase change and the temperature at which the phase change occurs. For example, the PCM barrier 322 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Additionally, the PCM barrier 322 may include multiple sheets of phase change material in the second portion 316. That is, multiple sheets of one type of PCM may be included in the PCM barrier 322 or multiple sheets each of a different type of PCM may be included in the PCM barrier 322.

The first film 318 and the second film 320 assist in enclosing the PCM barrier 322 in any instances where the PCM barrier 322 undergoes a phase change and is in liquid form. The first film 318 the second film 320 may also provide rigidity and support to the PCM barrier 322. Alternatively, the PCM barrier 322 may be formed of an encapsulated phase change material to be self-containing. In this instance also, the second portion 316 does not require the first film 318 and the second film 320 to contain the PCM barrier 322 when in liquid form, although the first film 318 and the second film 320 may still be included to provide support to the PCM barrier 322.

FIG. 6 is an enlarged schematic perspective illustration of a third embodiment of a portion of a window assembly 412 for the vehicle 10 (shown in FIG. 1). The window assembly 412 illustrated is a generally vertical window assembly 412. The window assembly 412 preferably includes a first portion 414 formed of glass or other transparent materials for forming windows, as is known in the art. A second portion 416 is located proximate to the first portion 414. The second portion 416 includes phase change material (PCM) barrier 422. A first film 418 and a second film 420 may also be included and enclose the PCM barrier 422.

In the embodiment shown the window assembly 412 is mounted to either a body 428 of the vehicle 10 or an interior panel 430 for the vehicle 10. A housing 432 is mounted to the body 428 or interior panel 430, as shown. For example, the housing 432 is mounted in the headliner of a vehicle 10 proximate to the window assembly 412. Alternately, the housing 432 may be removably mounted to the first portion 414 of the window assembly 412. For example the housing 432 may be secured to the first portion 414 using suction cups.

The second portion 416 is supported by and extends from the housing 432 to cover the first portion 414. The second portion 416 may be extended from the housing 432 to cover the first portion 414, or retracted within the housing 432 for storage. For example, the housing 432 and the second portion 416 could be a roller shade system or other type of window shade system. A securing mechanism 434 may be secured to the body 428 or the interior panel 430 on an opposing side of the window assembly 412 from the housing 432. In the instance when the housing 432 is secured to the first portion 414, the securing mechanism may also be secured on the first portion 414 spaced apart from the housing 432. The securing mechanism 434 assists in retaining the second portion 416 in a fully extended position that is proximate to the first portion. When the second portion 416 is in the fully extended position the second portion 416 covers a substantial area of the first portion 414 to absorb heat from the environment 424.

Alternatively, the housing 432 may pivot relative to the body 428 or the interior panel 430. The second portion 416 would pivot with the housing 432 in a visor-like manner. The second portion 416 could be pivoted away from the first portion 414 for storage and pivoted to cover at least a part of the first portion 414 to use the PCM barrier 422 to absorb heat.

As mention above, the second portion 416 includes the PCM barrier 422 that is located between a first film 418 and a second film 420. The second portion 416, including the first film 418, the second film 420, and the PCM barrier 422 may be rigid, as in part of a panel, or may be flexible to form a curtain over the first portion 414. In the embodiment shown the second portion 416 does not need to be transparent. The first portion 414 is retracted during vehicle 10 operation so the first portion 414 of the window assembly 412, which is transparent, may be seen through. When the vehicle 10 is not operating, the second portion 416 is extended to at least partially cover the first portion 414 to absorb heat from the environment 424 as described below.

The PCM barrier 422 absorbs heat from the environment 424 around the window assembly 412. The environment 424 may include the vehicle 10 (shown in FIG. 1) exterior or interior. The PCM barrier 422 may absorb heat from the exterior of the vehicle 10 to protect the interior of the vehicle 10, such as preventing the interior of the vehicle 10 from heating from the sun in warm climates. Absorption of heat by the PCM barrier 422 would assist in protecting components within the passenger compartment (not shown) of the vehicle 10 from damage caused by exposure to the heat and reduce wear on the components that may result from heat cycling. Additionally, the absorption of the exterior heat by the PCM barrier 422 may assist in maintaining a more comfortable temperature within the passenger compartment of the vehicle 10 when the vehicle 10 is parked or in use. Alternatively, the PCM barrier 422 may absorb heat from the interior of the vehicle 10 to prevent the vehicle interior from cooling, for example in cool climates, to assist in maintaining a comfortable temperature within the passenger compartment during vehicle 10 use, or when the vehicle 10 is parked.

The PCM barrier 422 absorbs heat from the environment 424 as the phase change material changes from a solid to a liquid. As the PCM barrier 422 absorbs heat the PCM barrier 422 approaches the point of the phase change for the material. The phase change of the PCM barrier 422 may or may not occur depending on the amount of heat being absorbed from the environment 424 at that time and the material selected for the PCM barrier 422. The material forming the PCM barrier 422 is selected based upon the ability of the material to absorb heat prior to the phase change and the temperature at which the phase change occurs. For example, the PCM barrier 422 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Additionally, the PCM barrier 422 may include multiple sheets of phase change material in the second portion 416. That is, multiple sheets of one type of PCM may be included in the PCM barrier 422 or multiple sheets each of a different type of PCM may be included in the PCM barrier 422.

The first film 418 and the second film 420 assist in enclosing the PCM barrier 422 in any instances where the PCM barrier 422 undergoes a phase change and is in liquid form. The first film 418 the second film 420 may also provide rigidity and support to the PCM barrier 422. Alternatively, the PCM barrier 422 may be formed of an encapsulated phase change material to be self-containing. In this instance also, the second portion 416 does not require the first film 418 and the second film 420 to contain the PCM barrier 422 when in liquid form, although the first film 418 and the second film 420 may still be included to provide support to the PCM barrier 422.

FIG. 7 is an enlarged schematic perspective illustration of a sixth embodiment of a portion of a window assembly 512 for the vehicle 10 (shown in FIG. 1). The window assembly 512 is a generally vertical window assembly 512. The window assembly 512 preferably includes a first portion 514 formed of glass or other transparent materials for forming windows, as is known in the art. A second portion 516 is located proximate to the first portion 514. The second portion 516 includes phase change material (PCM) barrier 522. A first film 518 and a second film 520 may also be included and enclose the PCM barrier 522.

In the embodiment shown the window assembly 512 is mounted to either a body 528 of the vehicle 10 or an interior panel 530 for the vehicle 10. A housing 532 is mounted to the body 528 or interior panel 530, as shown. For example, in the embodiment shown, the housing 532 may be mounted to the door of the vehicle 10 and the second portion 516 may extend upwardly from the door to cover a door window. Alternately, the housing 532 may be removably mounted to the first portion 514 of the window assembly 512. For example the housing 532 may be secured to the first portion 514 using suction cups.

The second portion 516 is supported by and extends from the housing 532 to cover the first portion 514. The second portion 516 may be extended from the housing 532 to cover the first portion 514, or retracted within the housing 532 for storage. For example, the housing 532 and the second portion 516 could be a roller shade system or other type of window shade system. A securing mechanism 534 may be secured to the body 528 or the interior panel 530 on an opposing side of the window assembly 512 from the housing 532.

In the instance when the housing 532 is secured to the first portion 514, the securing mechanism may also be secured on the first portion 514 spaced apart from the housing 532. The securing mechanism 534 assists in retaining the second portion 516 in a fully extended position that is proximate to the first portion 514. When the second portion 516 is in the fully extended position the second portion 516 covers a substantial portion of the first portion 514 to absorb heat from the environment 524.

As mentioned above, the second portion 516 includes the PCM barrier 522 and is located between a first film 518 and a second film 520. The second portion 516, including the first film 518, the second film 520, and the PCM barrier 522 may be rigid, as in part of a panel, or may be flexible to form a curtain over the first portion 514. In the embodiment shown, the second portion 516 does not need to be transparent. The first portion 516 is retracted within the housing 532 during vehicle operation so the first portion 514 of the window assembly 512, which is transparent, may be seen through. When the vehicle 10 is not in operating the second portion 516 is extended over the first portion 514 to absorb heat from the environment 524 as described below.

The PCM barrier 522 absorbs heat from the environment 524 around the window assembly 512. The environment 524 may include the vehicle 10 (shown in FIG. 1) exterior or interior. The PCM barrier 522 may absorb heat from the exterior of the vehicle 10 to protect the interior of the vehicle 10, such as preventing the interior of the vehicle 10 from heating from the sun in warm climates. Absorption of heat by the PCM barrier 522 would assist in protecting components within the passenger compartment (not shown) of the vehicle 10 from exposure to the heat and reduce wear on the components that may result from heat cycling. Additionally, the absorption of the exterior heat by the PCM barrier 522 may assist in maintaining a more comfortable temperature within the passenger compartment of the vehicle 10 when the vehicle 10 is parked or in use. Alternatively, the PCM barrier 522 may absorb heat from the interior of the vehicle 10 to prevent the vehicle 10 interior from cooling, for example in cool climates, to assist in maintaining a comfortable temperature within the passenger compartment during vehicle 10 use, or when the vehicle 10 is parked.

The PCM barrier 522 absorbs heat from the environment 524 as the phase change material changes from a solid to a liquid. As the PCM barrier 522 absorbs heat, the PCM barrier 522 approaches the point of the phase change for the material. The phase change of the PCM barrier 522 may or may not occur depending on the amount of heat being absorbed from the environment 524 at that time and the material selected for the PCM barrier 522. The material forming the PCM barrier 522 is selected based upon the ability of the material to absorb heat prior to the phase change and the temperature at which the phase change occurs. For example, the PCM barrier 522 may be formed from, materials including but not limited to crystalline alkyl hydrocarbons, paraffin, salt hydrates, poly-alcohols, and eutectics. One skilled in the art would be able to select the proper material for a particular application of the PCM barrier 22 within the vehicle 10.

Additionally, the PCM barrier 522 may include multiple sheets of phase change material in the second portion 516. That is, multiple sheets of one type of PCM may be included in the PCM barrier 522 or multiple sheets each of a different type of PCM may be included in the PCM barrier 522.

The first film 518 and the second film 520 assist in enclosing the PCM barrier 522 in any instances where the PCM barrier 522 undergoes a phase change and is in liquid form. The first film 518 and the second film 520 may also provide rigidity and support to the PCM barrier 522. Alternatively, the PCM barrier 522 may be formed of an encapsulated phase change material to be self-containing. In this instance also, the second portion 516 does not require the first film 518 and the second film 520 to contain the PCM barrier 522 when in liquid form; although the first film 518 and the second film 520 may still be included to provide support to the PCM barrier.

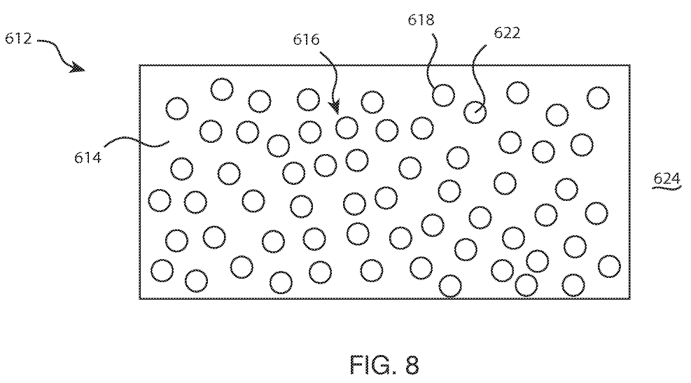

FIG. 8 is an enlarged schematic cross-sectional illustration of another embodiment of a window assembly 612 for the vehicle 10 of FIG. 1. The window assembly 612 includes a first portion 614 and a second portion 616. The second portion 616 is embedded within the first portion 614. The second portion 614 includes a PCM barrier 622 located within encapsulated beads 618. The encapsulated beads 618, containing the PCM barrier 622, are embedded within the first portion 614 when the first portion 614 is manufactured.

The PCM barrier 622 absorbs heat from the environment 624 around the window assembly 612 to protect the interior of the vehicle 10 (shown in FIG. 1). The environment 624 may include the vehicle 10 exterior or interior. For example, the PCM barrier 622 absorbs heat from the exterior of the vehicle 10 preventing the interior of the vehicle 10 from heating from the sun in warm climates. Absorption of heat by the PCM barrier 622 assists in protecting components within the passenger compartment (not shown) of the vehicle 10 and reduce wear on the components that may result from heat cycling. Additionally, the absorption of the exterior heat by the PCM barrier 622 assists in maintaining a more comfortable temperature within the passenger compartment of the vehicle 10 when the vehicle 10 is parked or in use. Alternatively, the PCM barrier 622 may absorb heat from the interior of the vehicle 10 to prevent the vehicle 10 interior from cooling, for example in cool climates, to assist in maintaining a comfortable temperature within the passenger compartment during vehicle 10 use, or when the vehicle 10 is parked.

The PCM barrier 622 absorbs heat from the environment 624 as the phase change material changes from a solid to a liquid; this is known as latent heat absorption. Although phase change materials can store and release energy for any phase change (i.e. solid to liquid, liquid to gas, etc) the embodiment disclosed is for the solid to liquid phase change. As the PCM barrier 622 absorbs heat the PCM barrier 622 approaches the temperature of the phase change for the material. When the PCM barrier 622 reaches the phase change temperature the PCM barrier 622 absorbs heat at an almost constant temperature, as is known. The PCM barrier 622 continues to absorb heat until the phase change is entirely complete. However, the phase change of the PCM barrier 622 may or may not occur depending on the amount of heat being absorbed from the environment 624 at that time and the material selected for the PCM barrier 622. Additionally, the PCM barrier 622 may only partially complete a phase change. The material forming the PCM barrier 622 is selected based upon the ability of the material to absorb heat prior to the phase change and the temperature at which the phase change occurs. For example, the PCM barrier 622 may be formed from materials including, but not limited to, crystalline alkyl hydrocarbons, paraffin, salt hydrates, poly-alcohols, and eutectics. One skilled in the art would be able to select the proper material for a particular application of the PCM barrier 622 within the vehicle 10.

Further, the encapsulated beads 618 may be either macro-encapsulated or micro-encapsulated. That is, the thickness of the PCM barrier 622, i.e. the diameter of the encapsulated beads 618, may vary. The thickness of the PCM barrier 622 may also determine the amount of heat the PCM barrier 622 can absorb. Alternatively, the encapsulated beads 618 may contain varying types of phase change material. That is, each encapsulated bead 618 may include of a different type of PCM barrier 622. The encapsulated beads 618 assist in enclosing the PCM barrier 622 in instances where the PCM barrier 622 undergoes a phase change and is in liquid form.

In one example of this embodiment, the first portion 614 may be glass for forming the window assembly 612. In this instance, the second portion 616, with the encapsulated beads 618 and the PCM barrier 622, is formed from transparent materials. After the first portion 612, i.e. the glass, and the second portion 616 are manufactured there is no visible difference to the appearance of the window assembly 612. That is, the window assembly 612 with the second portion 616 appears visibly the same as a window assembly made without the second portion 616.

Another example of a first portion 614 for this embodiment, is the first portion 614 may be a plastic panel for forming a window visor or sunroof shade for the window assembly 612. In this instance, the second portion 616, with the encapsulated beads 618 and the PCM barrier 622, is not required to be formed from transparent materials. Once the first portion 614, i.e. the visor or sunroof shade, is formed there is no visible difference to the appearance of the window assembly 612 with the second portion 616 as to a visor or sunroof shade made without the second portion 616.

Alternatively, the first portion 614 may be a flexible material for forming trim on a window component or flexible sunshade for the window assembly 612. In this instance, the second portion 616, with the encapsulated beads 618 and the PCM barrier 622, is not required to be formed from transparent materials. Once the first portion 614, i.e. the fabric or trim, is formed there is no visible difference to the appearance of the window assembly 612 with the second portion 616 as to trim or flexible material made without the second portion 616.

While the best modes for carrying out the invention have been described in detail, those familiar with the art to which this invention relates will recognize various alternative designs and embodiments for practicing the invention within the scope of the appended claims.

1. A window assembly for a vehicle comprising:
a first portion configured to be supported by the vehicle; and
a second portion located proximate to the first portion, wherein the second portion includes a phase change material (PCM) barrier.

2. The window assembly of claim 1, wherein the second portion further comprises:
a first film located on a first side of the PCM barrier; and
a second film located on a second opposing side of the PCM barrier.

3. The window assembly of claim 2, wherein the second portion is transparent.

4. The window assembly of claim 3, wherein the second portion is adhered to the first portion.

5. The window assembly of claim 1, wherein the first portion is supported by a body for the vehicle and further comprising:
a vehicle panel spaced apart from the vehicle body to define a cavity; and
wherein the second portion is at least partially located within the cavity.

6. The window assembly of claim 1, wherein a housing is mounted to the vehicle proximate to the first portion, and wherein the second portion extends from the housing to at least partially cover the first portion.

7. The window assembly of claim 1, further comprising:
a securing mechanism mounted to the vehicle proximate to the first portion and spaced apart from the housing to assist in retaining the second portion proximate to the first portion.

8. The window assembly of claim 1, wherein the second portion is encapsulated beads containing the PCM barrier embedded within the first portion.

9. The window assembly of claim 8, wherein the first portion is glass.

10. The window assembly of claim 8, wherein the first portion is a plastic window shade.

11. The window assembly of claim 8, wherein the first portion is a flexible material.

12. A window treatment comprising:
a barrier to be located proximate to a window such that the barrier substantially covers the window, and wherein the barrier includes a phase change material.

13. The window treatment of claim 12, wherein the barrier is transparent.

14. The window assembly of claim 13, wherein the barrier is adherable to the window.

15. The window treatment of claim 12, further comprising a housing mountable proximate to the window, and wherein the barrier extends from the housing to substantially cover the window.

16. The window treatment of claim 15, further comprising a securing mechanism mountable proximate to the window and spaced apart from the housing to assist in retaining the barrier proximate to the window.

17. The window treatment of claim 12, wherein the barrier includes encapsulated beads containing the PCM barrier embedded within.

18. The window treatment of claim 12, wherein the barrier is a plastic window shade.

19. The window treatment of claim 12, wherein the barrier is a flexible material.

20. A method of producing a window assembly for a vehicle comprising:
securing a first portion of a window assembly to a vehicle; and
adhering a second portion to the first portion, wherein the second portion has a phase change material (PCM) barrier.
